(19) United States
(12) Patent Application Publication
(10) Pub. No.: US 2012/0000122 A1
(43) Pub. Date: Jan. 5, 2012

(54) HEAT PROTECTIVE PLANT WRAP

(76) Inventor: James A. Zeiset, Salida, CO (US)

(21) Appl. No.: 12/830,339

(22) Filed: Jul. 4, 2010

(51) Int. Cl. A01G 13/02

(52) U.S. Cl. 47/30

(57) ABSTRACT

An improved heat protective plant wrap for surrounding a plant comprises: a paperboard sleeve having an open top end portion and an open bottom end portion; wherein the top end portion has interior faces therearound colored to absorb light. Sunlight is absorbed by the colored interior face in the top end portion rather than being reflected therein. A top portion of the plant therein, adjacent to the colored interior face, remains substantially closer to ambient temperature in the sunlight. In a preferred aspect of this invention the paperboard sleeve comprises a generally square tubular member having parallel pre-folded elongate arrises to facilitate storage, shipping, handling, and erection.

### FIELD OF THE INVENTION

This invention relates to protective paperboard plant wraps. More particularly this invention relates to an improved paperboard plant wrap which has an interior face which is darkened to absorb, rather than reflect light. When the interior face of the plant wrap absorbs light then a plant therein, remains considerably closer to ambient temperature.

### BACKGROUND OF THE INVENTION

Small plant wraps are used with green house plants. They prevent root entanglement between adjacent plants, and thereby facilitate faster sorting according to plant development, as well as transplanting with minimal root shock and root damage. The square containers enable the most efficient use of greenhouse space. Larger plant wraps are used to help newly planted vines or seedlings adapt to a vineyard or orchard environment upon transplanting. Plant wraps help protect a plant from excessive sunlight and wind, they deflect heat, deter rodents, and guard against herbicide spray. When sunlight enters the open top of the wrap, upward growth of the plant is promoted. Plant wraps are available in a heat sealed drop-on style or alternatively, as a staple-on wrap for plants with larger canopy development. Each style comes in several sizes which vary in widths and heights. These larger plant wraps are most commonly 2-3″ square and 18″ in length. However, widths and lengths doubling these sizes are not uncommon. Most plant wraps are made from a polyethylene coated paperboard which is similar to that which is used in milk cartons. Paperboard plant wraps are generally preferred because of their low cost, easier handling, and effectiveness. Larger nurseries frequently have the exterior of these plant wraps printed in color with their names, logos and other information. Paperboard plant wraps have been used for approximately twelve years. Tens of millions of these paperboard plant wraps are sold annually.

Relatively expensive plant wraps having aluminum foil laminated on their exterior side portion have been used for several years. These light reflective wraps are sold to protect young plants from the effects of excessive sun. Particularly in the summer months of June and July, when the sun is most direct and hottest, young plants can be totally or partially lost due to intense sunlight. When the cambium layer, that layer just which transmits moisture just under the bark, reaches 120° F., permanent damage occurs. These wraps which are laminated with aluminum foil to reflect sunlight are helpful, but still many plants are lost. The cost of a lost plant is not limited to a lost year of production and the labor required to regrow and replace the plant. If an orchard has dwarf and non-uniform tree sizes it is difficult to harvest with mechanical equipment.

The inventor herein has observed that it usually was the portion of the plant just beneath the top portion of the plant wrap which is most severely damaged by heat. To confirm this he measured the bark temperature of a sapling just above, and just below the top edge portion of a plant wrap. Typically the temperature of the sapling exposed to direct light just above the plant wrap was 6° above ambient air temperature. However, the temperature just below the top edge of the wrap was 22° above the ambient temperature! The temperature just below the top rim of the wrap was 16° higher than the temperature just above the top rim of the wrap which was exposed to direct sunlight. He speculated that sunlight, entering the interior of the wrap on an angle, and then reflecting back and forth across the plant was a major factor contributing to plant over heating. He continued on, again measuring the temperature of the cambium layer 1½ inches above, and 1½ inches below a top edge of the wrap at varying temperatures with i) standard plant wraps, ii) foil covered plant wraps, iii) with plant wraps having a black interior face, and iv) with plant wraps having both foil coverings and a black interior face. What he found surprised him. Plant wraps which had an exterior covered with foil resulted in temperature differences, when measured above and below the top rim of the plant wrap of 15°. Plant wraps which had a black interior to absorb light had temperature differences of 11°, and plant wraps which had both an exterior covered with foil and a black interior had temperature differences of 10°. His suspicions were confirmed. The primary cause of plant overheating when a plant wrap was used was sunlight entering the interior top portion of the plant wrap and reflecting therein! Surprisingly, a plant wrap having a black interior portion was five times more effective than the generally accepted industry standard, a plant wrap fabricated from milk carton material having an uncolored interior!

### OBJECTS OF THE INVENTION

It is an object of this invention to disclose a plant wrap offering substantially improved protection against overheating. It is an object of this invention to disclose a plant wrap which will substantially reduce plant loss due to overheating. It is yet a further object of this invention to disclose a plant wrap which will substantially reduce costs associated with plant loss, replacement, lost production, and non-uniform tree sizes in orchards.

One aspect of this invention provides for an improved heat protective plant wrap for surrounding a plant comprising: a paperboard sleeve having an open top end portion and an open bottom end portion; wherein the top end portion has interior faces therearound colored to absorb light. Sunlight is absorbed by the colored interior face in the top end portion rather than being reflected therein. A top portion of the plant therein, adjacent to the colored interior face, remains substantially closer to ambient temperature in the sunlight.

In a preferred aspect of this invention the paperboard sleeve comprises a generally square tubular member having parallel pre-folded elongate arises to facilitate storage, shipping, handling, and erection.

Various other objects, advantages and features of this invention will become apparent to those skilled in the art from the following description in conjunction with the accompanying drawings.

### FIGURES OF THE INVENTION

FIG. 1 is a perspective view of a paperboard plant wrap containing a plant.

FIG. 2 is a perspective view of an improved heat protective paperboard plant wrap having an interior top side portion having an interior face blackened to absorb light. FIG. 2 also shows an exterior reflective foil coating, a convention used throughout the industry, to reduce plant overheating.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

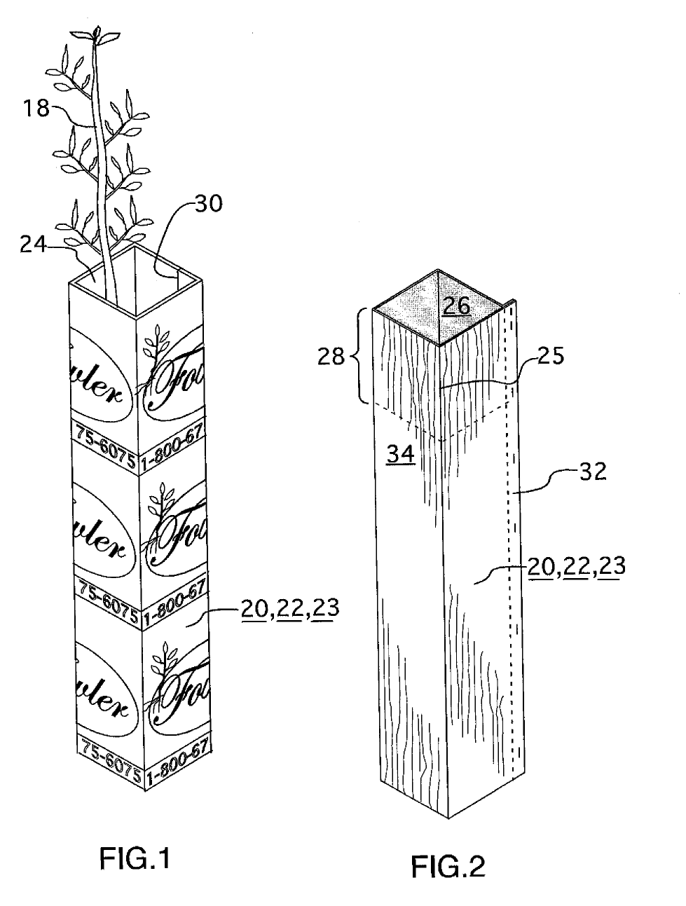

Turning now to the drawings and more particularly to FIG. 1 we have a perspective view of a paperboard plant wrap 20 containing a plant 18. FIG. 2 is a perspective view of an improved heat protective paperboard plant wrap having an interior top side portion having an interior face blackened to absorb light. FIG. 2 also shows an exterior reflective foil coating 34, a convention used throughout the industry, to reduce plant overheating. Most generally, an improved heat protective plant wrap 20 for surrounding a plant 18 comprises: a paperboard sleeve 22 having an open top end portion and an open bottom end portion; wherein the top end portion 28 has interior faces 24 therearound colored 26 to absorb light. Sunlight is absorbed by the colored interior face in the top end portion 28 rather than being reflected therein. This results in a top portion of the plant 18 therein, adjacent to the colored interior face 26, remaining substantially closer to ambient temperature in the sunlight.

In a preferred aspect of this invention the paperboard sleeve comprises a generally square tubular member 23 having parallel pre-folded elongate arrises 25 to facilitate storage, shipping, handling, and erection. In the most preferred embodiment of the invention the top interior face is colored by printing with black ink. Within this specification colored is intended and defined to include black. Printing on two sides of the paperboard is difficult. No box fabrication manufacturers produce a machine which can print on the inside of a box.

The paper board is covered with a layer of polyethylene prior to printing. Most generally a longitudinal seam 30 along the tubular member is attached with a heat seal. (As shown on FIG. 1) Alternatively, for plants with larger canopy development, longitudinal edges 32 of the paperboard forming the tubular member 23 are configured to be stapled together after the paperboard surrounds the plant 18.

While the invention has been described with preferred specific embodiments thereof, it will be understood that this description is intended to illustrate and not to limit the scope of the invention, which is defined by the following claims.

I claim:

1. A plant wrap for surrounding a plant comprising:
a paperboard sleeve having an open top end portion and an open bottom end portion;
wherein the top end portion has interior faces therearound colored to absorb light;
so that sunlight is absorbed by the colored interior face in the top end portion rather than being reflected therein; and,
so that a top portion of the plant therein, adjacent to the colored interior face, remains substantially closer to ambient temperature in the sunlight.

2. A plant wrap as in claim 1 wherein the paperboard sleeve comprises a generally square tubular member having parallel pre-folded elongate anises to facilitate storage, shipping, handling, and erection.

3. A plant wrap as in claim 2 wherein the top interior face is colored by printing with black ink.

4. A plant wrap as in claim 3 wherein the paper board is covered with a layer of polyethylene prior to printing.

5. A plant wrap as in claim 4 wherein a longitudinal seam along the tubular member is attached with a heat seal.

6. A plant wrap as in claim 4 wherein longitudinal edges of the paperboard forming the tubular member are structured to be stapled together after the paperboard surrounds the plant.
